(19) United States
(12) Patent Application Publication
(10) Pub. No.: US 2016/0379290 A1
(43) Pub. Date: Dec. 29, 2016

(54) Systems and Methods for Generating Competitive Merchant Sets for Target Merchants

(71) Applicant: MASTERCARD INTERNATIONAL INCORPORATED, Purchase, NY (US)

(72) Inventors: Henry M. Weinberger, New York, NY (US); Ramamohan Reddy Sangasani, White Plains, NY (US); Rohit Chauhan, Somers, NY (US)

(21) Appl. No.: 15/179,262

(22) Filed: Jun. 10, 2016

Related U.S. Application Data
(60) Provisional application No. 62/183,957, filed on Jun. 24, 2015.

(51) Int. Cl. G06Q 30/06; G06Q 30/02; G06Q 20/10; G06Q 20/22

(52) U.S. Cl. CPC G06Q 30/0629; G06Q 20/227; G06Q 30/0201; G06Q 20/10

(57) ABSTRACT

Exemplary systems and methods for generating competitive merchant sets for target merchants are disclosed. One exemplary method includes compiling a sample of merchants from the database of merchants based on a geographic region and/or an industry associated with the merchants; selecting a target merchant from the sample of merchants; and generating from the merchants in the compiled sample of merchants, by a computing device, a competitive merchant set for the target merchant, based on the target merchant and each merchant in the competitive merchant set including at least one transaction to the same payment account

### CROSS-REFERENCE TO RELATED APPLICATION

This application claims the benefit of, and priority to, U.S. Provisional Application No. 62/183,957 filed on Jun. 24, 2015. The entire disclosure of the above application is incorporated herein by reference.

### FIELD

The present disclosure generally relates to systems and methods for generating competitive merchant sets for target merchants, based on one or more comparisons with other merchants such as, for example, proximity, industry, ticket size, historic relation, etc.

### BACKGROUND

This section provides background information related to the present disclosure which is not necessarily prior art.

Payment accounts are known to be used to purchase a variety of different goods and services from merchants. Payment accounts are generally associated with credit cards, debit cards, prepaid cards, and other payment forms, which are used to post transactions to payment accounts. Transactions to such payment accounts are subject to approval or rejection, by communication of the transactions through a payment network. Different entities involved in passing the transactions through the payment network often gather information related to the transactions. Separately, merchants are known to compete with other merchants to provide goods and services to consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in generating, or compiling, a competitive merchant set for a target merchant;

FIG. 2 is a block diagram of a computing device that may be used in the exemplary system of FIG. 1;

FIG. 3 is an exemplary method for generating a competitive merchant set for a target merchant, which may be implemented in the system of FIG. 1;

FIG. 4 is an exemplary relationship tree for determining a historic relation score according to some aspects of the present disclosure; and

FIG. 5 is another exemplary method for generating a competitive merchant set for a target merchant, which may be implemented in the system of FIG. 1.

Corresponding reference numerals indicate corresponding parts throughout the several views of the drawings.

### DETAILED DESCRIPTION

Example embodiments will now be described more fully with reference to the accompanying drawings.

Merchants often assess whether certain other merchants are competitors based on their perceptions of not only the other merchants, but also themselves. When a merchant's perceptions are errant, one or more certain merchants may be identified as a competitor to the merchant, when in fact, they are not. The systems and methods herein generate competitive merchant sets for a target merchant, based on objective measures or relationships between the target merchant and other merchants, such as, for example, industry, ticket size, proximity and historic relations. By use of such objective measures, competitive merchant sets may be generated, which are more precise than the merchant's perception and, thus, which may be used to improve strategies in competing with the other merchants.

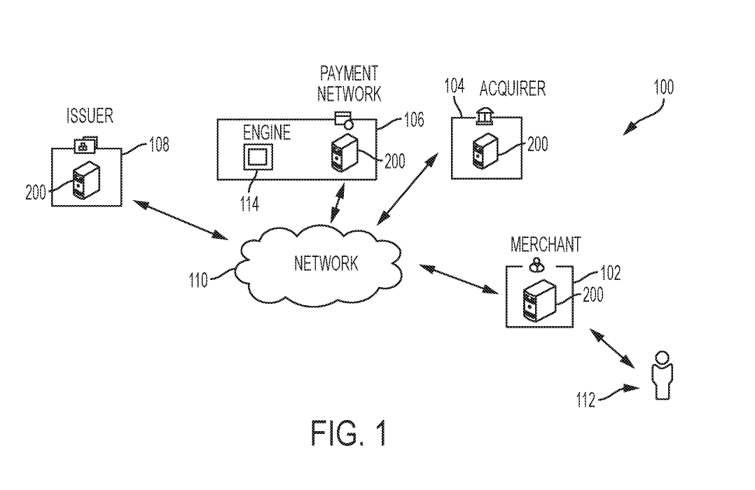

FIG. 1 illustrates an exemplary system 100, in which the one or more aspects of the present disclosure may be implemented. Although, in the described embodiment, parts of the system 100 are presented in one arrangement, other embodiments may include the same or different parts arranged otherwise, depending, for example, on authorization processes for payment transaction systems.

Referring to FIG. 1, the system 100 generally includes a merchant 102, an acquirer 104, a payment network 106, and an issuer 108, each coupled to network 110. The network 110 may include, without limitation, a local area network (LAN), a wide area network (WAN) (e.g., the Internet, etc.), a mobile network, a virtual network, and/or another suitable public and/or private network capable of supporting communication among two or more of the components illustrated in FIG. 1, or any combinations thereof. For example, network 110 may include multiple different networks, such as a transaction network made accessible by the payment network 106, and separately, the Internet through which the consumer 112 may communicate with the merchant 102.

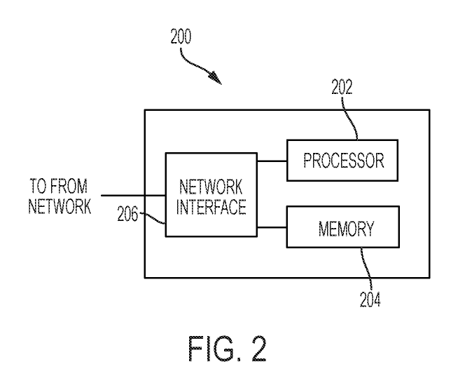

Each of the merchant 102, the acquirer 104, the payment network 106, and the issuer 108 in the illustrated system 100 may be implemented in any one or more computing devices, such as a computing device or multiple computing devices located together, or distributed across a geographic region. For illustration, the system 100 is further described below with reference to an exemplary computing device 200 illustrated in FIG. 2. The system 100, and the components therein, however, should not be considered to be limited to the computing device 200, as different computing devices and/or arrangements of computing devices may be used in other embodiments.

As shown in FIG. 2, the exemplary computing device 200 includes a processor 202 and a memory 204 coupled to the processor 202. The processor 202 may include, without limitation, a central processing unit (CPU), a microprocessor, a microcontroller, a programmable gate array, an ASIC, a logic device, or the like. The memory 204 is a computer readable media, which includes, without limitation, random access memory (RAM), a solid state disk, a hard disk, compact disc read only memory (CD-ROM), erasable programmable read only memory (EPROM), tape, flash drive, and/or any other type of volatile or nonvolatile physical or tangible computer-readable media. Memory 204 may be configured to store, without limitation, transaction data, consumer information, merchant information, and/or other types of data suitable for use as described herein.

The computing device 200 further includes a network interface 206 coupled to the processor 202. The network interface 206 may include, without limitation, a wired network adapter, a wireless network adapter, a mobile telecommunications adapter, or other device capable of communicating to one or more different networks, including the network 110. In at least one embodiment, computing device 200 includes processor 202 and one or more network interfaces 206 incorporated into or with processor 202.

Referring again to FIG. 1, the merchant 102, the acquirer 104, the payment network 106, and the issuer 108 cooperate, in response to a request from a consumer 112, to complete a payment transaction.

As an example, in a payment account transaction in the system 100, the merchant 102 reads a payment device (e.g., a payment card or other device enabled to facilitate payment account transactions, etc.) and communicates the account number and an amount of the purchase to the acquirer 104 to determine whether the payment device and associated payment account are in good standing and whether there is sufficient credit/funds to complete the transaction. The acquirer 104, in turn, communicates with the issuer 108 through a payment network 106, such as, for example, a payment system/service using the MasterCard® interchange, for authorization to complete the transaction. If the issuer 108 accepts the transaction, an authorization is provided back to the merchant 102, via the acquirer 104, and the merchant 102 completes the transaction. The transaction is posted to the payment account associated with the consumer 112. The transaction is later settled and cleared by and between the merchant 102, the acquirer 104, and the issuer 108. In numerous exemplary transactions, a transaction may further include the use of a personal identification number (PIN) authorization, or other steps associated with identifying and/or authenticating a payment account and/or the consumer 112, etc.

Transaction data is generated, collected, and stored as part of the above interactions among the merchant 102, the acquirer 104, the payment network 106, the issuer 108, and the consumer 112. The transaction data includes, without limitation, the payment account number, ticket size (i.e., an amount of the transaction), merchant identification (ID), merchant category code (MCC), location of the transaction, and a date/time of the transaction, etc. The transaction data may further include, in certain embodiments, product specific information, such as model numbers, brands, price per product and/or service, etc. It should be appreciated that still other transaction data related to transactions, products, consumers, acquirers, and/or merchants may further be collected and/or stored within the system 100, as part of, or associated with, authorizing, settling and/or clearing the transactions to payment accounts.

The transaction data representative of the above transaction, as well as transaction data for multiple other transactions in the system 100, involving multiple different consumers and merchants, is stored in various parts of the system 100. In various embodiments, the payment network 106, for example, collects and stores the transaction data in memory 204. In particular, the payment network 106 stores transaction data for multiple payment accounts, each associated with one or more consumers including, for example, consumer 112. The transaction data may be stored in memory 204, according to one or more of the particular payment account, the acquirer 104 (or other acquirer in the system 100), the issuer 108 (or other issuer in the system 100) and/or the merchant 102 (or other merchant in the system 100) involved in the transaction, and/or any other criteria. Additionally, or alternatively, in various embodiments, the acquirer 104, the issuer 108, or other parts of the system 100, or other entities, may collect transaction data, and/or store the transaction data in the memory 204 associated therewith.

In addition, the payment network 106 further includes, in memory 204, a database of merchants (i.e., a merchant database) including, for example, merchant 102. The merchants included in the database are generally involved in transactions to payment accounts identified by, or known to, the payment network 106. In various embodiments, the payment network 106 may permit the merchants to register to the database, or otherwise identify the merchants to the database, in order to, for example, offer products and/or services to the merchants.

With continued reference to FIG. 1, the system 100 further includes an engine 114, which is configured, often by computer-executable instructions, to generate competitive merchant sets (or sets of competitive merchants) for target merchants, such as merchant 102, etc. In particular, the engine 114 is configured to access the transaction data described above, and compile a sample of merchants, which includes a target merchant, such as merchant 102 in the following description. Through a variety of analyses, using objective indicia/parameters, which may involve determining tree structures or relationships, comparing ticket sizes, or comparing locations, etc., the engine 114 then identifies certain ones of the merchants to (or includes them in) a competitive merchant set for the target merchant 102. The engine 114 may generate the competitive merchant sets based on a variety of uses, either directly, or conditionally, of the parameters, potentially depending on one or more thresholds, described with respect to the exemplary methods herein.

While the engine 114 is illustrated as part in the payment network 106 in the system 100, it should be appreciated that the engine 114 may be a standalone part of system 100, or the engine 114 may be integrated in other parts of system 100 either shown in FIG. 1 (e.g., the acquirer 104, the issuer 108, etc.) or not shown, or the engine 114 may be included otherwise in one or more different system embodiments. Moreover, despite being illustrated as separate from the computing device 200 of the payment network 106, the engine 114 is considered herein to be a computing device in and of itself (consistent with computing device 200), and specifically, the processor 202 thereof, configured by the one or more computer-executable instructions, to cause the processor 202 to perform as described herein.

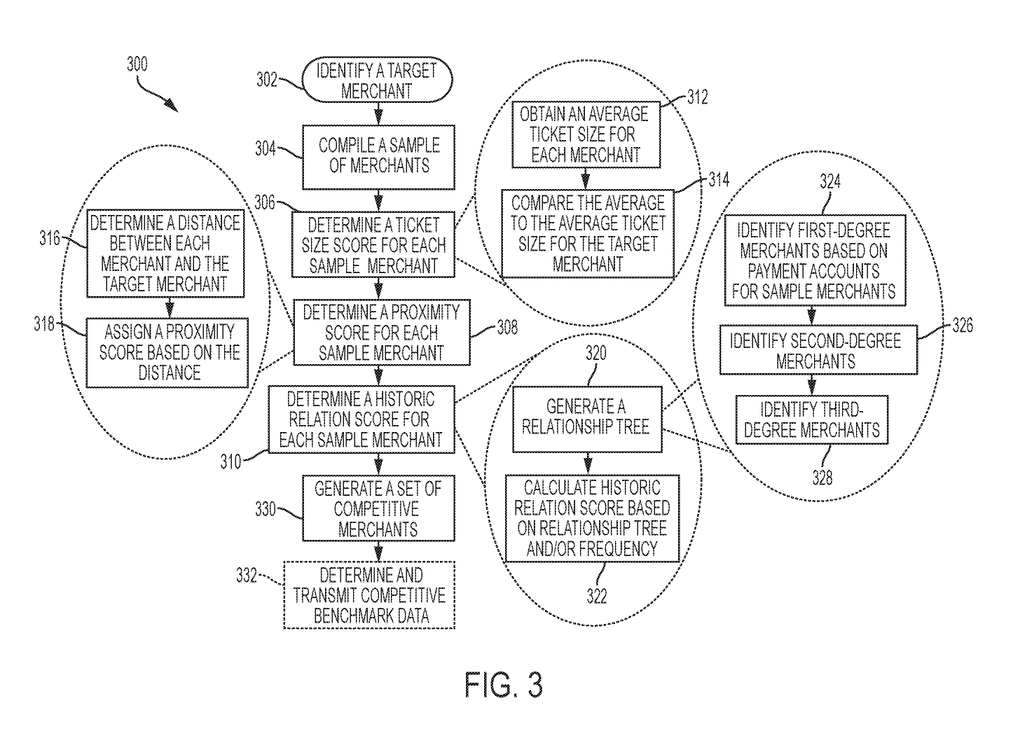

FIG. 3 illustrates an exemplary method 300 of generating a competitive merchant set for a target merchant. For purposes of illustration, the exemplary method 300 is described herein with reference to engine 114 of FIG. 1 and computing device 200 of FIG. 2. However, it should be appreciated that the methods described herein are not limited to the system 100 or the engine 114, or computing device 200. And, conversely, the systems and computing devices described herein are not limited to the exemplary method 300.

As part of the exemplary method 300, the engine 114 identifies a target merchant (merchant 102 hereinafter), at 302, for which the competitive merchant set is to be created, and then compiles a sample of merchants, at 304, for the target merchant 102. The sample of merchants may be compiled, for example, from a database of merchants, in memory 204, for example, of the engine 114, of the payment network 106, etc. Each merchant in the sample typically has some relation to the target merchant 102, such that each merchant may be considered as a possible competitor with the target merchant 102. The sample of merchants may be selected using any suitable selection criteria indicative of a potential relationship between the merchants and the target merchant 102, competitive or otherwise, and including, for example, merchants located within a certain proximity of the target merchant 102 (e.g., based on geographical distance, travel time over roads, and/or same ZIP code, city, or country, etc.), merchants having the same or similar average ticket size(s) (e.g., based on an average of all ticket sizes within a fixed dollar amount, a median of a subset of the ticket sales within a fixed dollar amount, an average of all ticket sizes within a predefined interval within a fixed percentage range, etc.), merchants having a historic relation to the target merchant 102 (e.g., having transactions included in the same payment accounts of one or more customers, having an amount of overlap in a relationship tree, etc.), merchants within the same industry or category (e.g., based on MCC, etc.) as the target merchant 102, etc.

The sample of merchants may be compiled using any one of the above selection criteria or any one or more other selection criteria, or may be compiled using a combination of selection criteria. For example, the sample of merchants may include all merchants: i) having transactions included in the same payment accounts as the target merchant 102, ii) within ten miles of the target merchant 102 and iii) having an average ticket price/size within thirty dollars of the target merchant 102. In another example, the sample of merchants may be all merchants (from the merchant database), which are located in the same region (e.g., country, etc.) and/or are within the same industry as the target merchant 102. For example, if the target merchant 102 has a restaurant MCC, the compiled set of would-be competitor merchants may only include merchants also having a restaurant or eating place MCC. It is understood that in other embodiments, various selection criteria, ranges and/or values may be used to compile the sample of merchants.

As described, information about the merchants (e.g., location, average ticket price, MCC, etc.), and/or transaction data for multiple customers of the merchants is often stored in memory 204, for example, at the payment network 106 or directly at the engine 114. In either case, the engine 114 may access the memory 204, to retrieve merchant locations, average ticket sizes, transaction history for customer payment accounts, etc., and may use this information to determine distances between merchants, differences between average ticket sizes, merchants included in the same payment accounts of different customers based on transaction data, etc., and ultimately, with reference to operation 304, compile a sample of merchants related to the target merchant 102.

In the illustrated method 300, after compiling the sample of merchants, as shown in FIG. 3, the engine 114 determines a ticket size score for each merchant in the sample, at 306, a proximity score for each merchant in the sample, at 308, and a historic relation score for each merchant in the sample, at 310. While each is illustrated in a particular order in FIG. 3, it should be appreciated that the scores may be determined in any order, or at the same time, in different embodiments. Further, the engine 114 may rely on less than all scores and/or criteria, in determining the competitive merchant set, such that, one or more scores, as described, may not be determined in some embodiments. In still further embodiments, the engine 114 may generate the set of competitive merchants, based on the criteria described herein, directly (based on one or multiple parameters), without separately generating one or more scores.

The engine 114 determines a ticket size score for each merchant in the sample, at 306, based on ticket size data for the merchant relative to ticket size data for the target merchant 102. As part of determining a ticket size score, at 306, the engine 114 optionally (as indicated by the dotted lines in FIG. 3) obtains or calculates an average ticket size for the merchant, at 312. The engine 114 then compares the average ticket size for the merchant with an average ticket price/size for the target merchant 102, at 314. Thus, in the method 300, the ticket size score may be based on an average ticket size for the merchant relative to an average ticket size for the target merchant 102.

It should be appreciated that the ticket size score may be based on any suitable ticket size data, such as, for example, an average ticket size as indicated in FIG. 3, a median ticket size, a mode ticket size, a total ticket size, etc.

Ticket size scores may be further based on all ticket size data, or may be based on only a portion of ticket size data for each merchant. For example, in some embodiments, the engine 114 determines a ticket size score based on ticket size data within a predefined time interval (e.g., the last year, the last three months, only after 5:00 p.m., only on the weekends, etc.) or a subset of the ticket size data (e.g., ignoring the top percentages and bottom percentages, including only ticket sizes within a range, etc.). In various embodiments, the exemplary method 300 may use any suitable combination, formula or mathematical operation indicative of general ticket size at each merchant. Moreover, the engine 114 calculates an average ticket size for each merchant in the illustrated method 300, while in other embodiments, the engine 114 does not calculate the ticket size, but retrieves an average ticket size score for each merchant previously stored in memory 204.

The ticket size score, in various embodiments, may be higher to indicate a less competitive relationship, or alternatively, lower to indicate a more competitive relationship. For example, if the target merchant 102 has an average ticket price of $15.00, a merchant in the sample having an average ticket price of $20.00 may have a higher ticket size score than a merchant in the sample having an average ticket price of $16.00. In this example, a lower ticket size score indicates a closer average ticket price between the target merchant 102 and a merchant in the sample, and an increased likelihood of competition therebetween.

Further, as shown in FIG. 3, the engine 114 determines a proximity score for each merchant in the sample, at 308. As part of determining a proximity score, the engine 114 optionally (as indicated by the dotted lines) determines a distance between each merchant and the target merchant 102, at 316, and assigns a proximity score based on the distance therebetween, at 318. The proximity score, in this example, is based on a distance (e.g., a straight line geographical distance between the merchants; a difference in latitude and/or longitude′ an amount of time to travel between the merchants along roads, walking, using public transportation; etc.). In other embodiments, the proximity score is based on whether a merchant in the sample is located within a predetermined boundary with the target merchant 102 (e.g., ZIP code, city, county, etc.). The engine 114 may retrieve locations for each merchant, stored in memory 204, and then determine a distance between the merchants and/or whether the merchants are located within the same boundary, etc. In one example, a merchant in the sample located 2.4 miles from the target merchant 102 may have a lower proximity score than a merchant in the sample located 8.0 miles from the target merchant 102. In this example, again, a lower proximity score may be indicative of a closer distance between the merchant and the target merchant, and an increased likelihood of competition therebetween.

As shown in FIG. 3, the engine 114 further determines a historic relation score for each merchant in the sample, at 310. As a part of determining the historic relation score at 310, the engine 114 optionally generates a relationship tree from the sample of merchants at 320. The engine 114 then calculates the historic relation score based on an amount of overlap of a merchant in the sample in the relationship tree with the target merchant 102, at 322. The historic relation score may be calculated or determined, in some examples, by assigning a score based on the position of the merchant in the relationship tree, or in other examples, based on the overlap of the merchant in one or more payment accounts, or in still other embodiments, based on the position of the merchant in the relationship tree and the overlap of the merchants in one or more payment accounts.

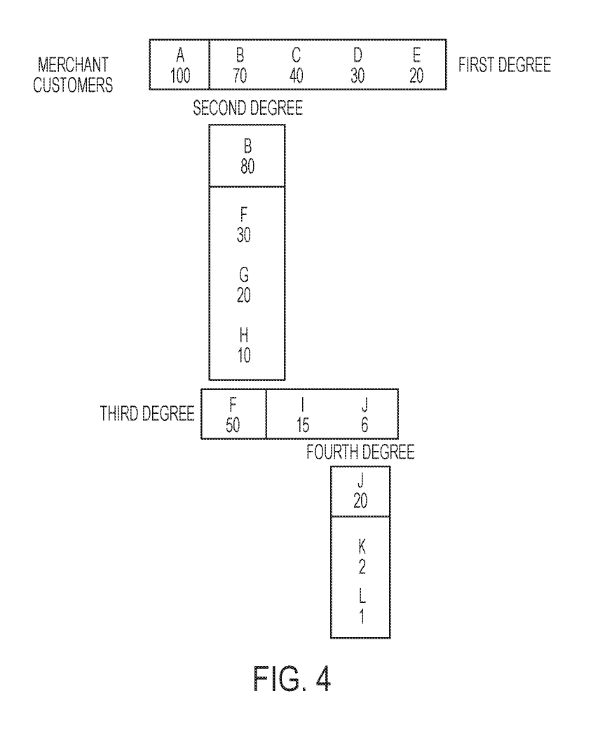

FIG. 4 illustrates an example relationship tree. Of 100 customers that have a payment account transaction involving Merchant A (the target merchant in this example), 70 of them also have a payment account transaction involving Merchant B, 40 of them also have a payment account transaction involving Merchant C, etc. These merchants (i.e., Merchant B, Merchant C, Merchant D and Merchant E) are considered to have a direct overlap with the target merchant because they share customers that have a transaction to both the merchant and the target merchant in the same payment account. These directly overlapping merchants may also be considered as first-degree merchants because there is only one degree of connection therebetween. The amount of direct overlap may be determined by the amount of customers shared between a first-degree merchant and the target merchant. In this example, Merchant B has a greater amount of direct overlap with the target merchant (Merchant A) than Merchant C because 70 of target Merchant A's customers also visited Merchant B, while only 40 of target Merchant A's customers also visited Merchant C.

Merchants that are connected to the target merchant through more than one degree of overlapping customer payment account transactions have an indirect overlap with the target merchant. For example, merchants connected to the target merchant through two degrees of overlapping customer payment accounts are considered second-degree merchants. In the example of FIG. 4, second-degree merchants can be determined by looking at customers that have a payment account transaction involving Merchant B (i.e., a first-degree, directly overlapping merchant), but not a payment account transaction involving the target Merchant A. Of the 80 customers that have a payment account transaction involving Merchant B (and not Merchant A), 30 also have a transaction at Merchant F, 20 also have a transaction at Merchant G, etc. Merchants F, G, and H are considered second-degree merchants. Although not shown in FIG. 4, a separate second-degree branch could also be created for each of the other first-degree merchants (i.e., Merchant C, Merchant D, and Merchant E).

The amount of indirect overlap between a merchant and the target merchant may then be determined by the amount of customers shared between a second-degree merchant and a first-degree merchant. In this example, Merchant F has a greater amount of indirect overlap with target Merchant A than does Merchant G because 30 of first-degree Merchant B's customers also visited second-degree Merchant F, while only 20 of Merchant B's customers also visited second-degree Merchant G. Alternatively, or in addition, the amount of indirect overlap may also be based on the amount of direct overlap of the first-degree merchant through which the second-degree merchant is connected to the target merchant. In this example, second-degree merchants connected to first-degree Merchant B may have a greater amount of overlap than any second-degree merchants connected to first-degree Merchant C (not shown) because Merchant B has a greater amount of direct overlap with the target Merchant A than Merchant C has with Merchant A.

This process can be continued to develop further indirect overlap relationships in the tree. In this example, Merchants I and J are third-degree merchants with an indirect overlap to target Merchant A because they share customers with second-degree Merchant F. Further, Merchants K and L are fourth-degree merchants with an indirect overlap because each shares customers with third-degree Merchant J. The process of extending the relationship tree could be extended as far as desired, and the number of branches (e.g., levels, degrees, etc.) may be limited, for example, based on how many merchants are desired for the competitive set. Alternatively, or in addition, the length of the branches may be limited based on a threshold of the amount of overlap. For example, the threshold cutoff may be about 25%, such that any merchants having an amount of overlap of less than 25% will not be included. In the example of FIG. 4, a 25% cutoff would permit Merchant D (in which 30 of target Merchant A's 100 customers overlap with Merchant D) to be included in the relationship tree, but Merchant E and any other merchants in the first branch having less than 25 overlapping customers would be excluded.

Referring again to FIG. 3 the example tree is constructed, by the engine 114, in levels, with first-degree merchants being identified, at 324. Again, the first-degree merchant is a sample merchant involved in a transaction in a payment account, in which the target merchant 102 is also involved in a transaction. Generally, a first-degree merchant is a merchant that has appeared in the same payment accounts as the target merchant 102. For example, transaction data for a payment account (e.g., for the consumer 112) includes a transaction at target merchant, ABC Pizza, and a transaction at another merchant, DEF Thai. DEF Thai, is thus a first-degree merchant relative to ABC Pizza in the relationship tree, because ABC Pizza (“the target merchant”) has customers that also patronize DEF Thai, using the same payment account.

The relationship tree, as explained above, may further include second degree merchants. The second-degree merchants are identified, by the engine 114, from the sample of merchants, at 326. In this embodiment, the tree is constructed in order by level, a first level, then second level, then third level, etc. As such, second-degree merchants are not first-degree merchants, whereby a merchant will not be tested to be a second-degree merchant, if it has already been identified as a first-degree merchant. Instead, in this embodiment, a second-degree merchant is a merchant in the sample, which is involved in a transaction in a payment account, which includes a transaction involving a first-degree merchant (but not the target merchant 102). In the restaurant example above, when a payment account includes a transaction involving DEF Thai (i.e., a first-degree merchant) and XYZ Chinese, XYZ Chinese is identified as a second-degree merchant (as long as no payment account includes both ABC Pizza (the target merchant) and XYZ Chinese)). In this embodiment, third-degree merchants are identified, by the engine 114, in a similar manner, at 328. A third-degree merchant is not a first-degree merchant or a second-degree merchant, but is involved in a transaction to a payment account, to which a second-degree merchant is involved in a transaction.

This process may be repeated for each level of the tree, until the tree has expanded to a desired number of levels, as described above with reference to FIG. 4. It should be apparent that the relationship tree may be expanded to any suitable number of levels by expanding the tree to include additional degrees of merchants in the sample using the transaction data of customers of the merchants in the sample. In various aspects, though, the relationship tree may be limited to a particular number of levels (e.g., one level, two levels, etc.) to help ensure improved accuracy in determining the historic relation score. Further, in various embodiments, only one level of merchants, for example, first-degree merchants, may be used in connection with determining the historic relation score (as the relationship of first degree merchants and a target merchant, in these embodiments, may be more important than other relationships).

The historic relation score then may be based on one or more of several other or additional parameters. One parameter may include which degree branch the merchant resides on. In the example of FIG. 4, Merchant B resides on the first-degree branch and thus has a stronger historic relation score than Merchant I which resides on the third-degree branch. The engine 114 may calculate a lower historic relation score for Merchant B, than for Merchant I. Thus, in this example, a lower historic relation score indicates more overlap between customers of the merchant and the target merchant, and an increased likelihood of competition therebetween. Additionally, or alternatively, in determining the historic relation score, customer overlap may be used. For example, in FIG. 4, Merchant B has 70% overlap with target Merchant A, and thus a stronger historic relation score, than Merchant D which only has a 30% overlap. An amount of overlap may generally refer to an amount of direct overlap and/or an amount of indirect overlap, and may include any of the above listed historic relation score parameters, or other additional parameters indicating a relationship with the target merchant through customer payment accounts. The amount of overlap may be determined using any measure or factor, or by any formula (weighted or un-weighted) to determine direct and/or indirect overlap.

Yet another parameter that may be used to determine a historic relation score includes an amount of offshoot for merchants having only an indirect overlap or at least a second-degree relationship with the target merchant. The amount of offshoot may be determined by looking at where the second-degree (or further degree) branch was formed. For example, in FIG. 4, a second-degree merchant on a branch stemming from Merchant B will have a stronger historic relation score than a second-degree merchant on a branch stemming from Merchant D because Merchant B has a stronger overlap with the target Merchant A than Merchant D does.

As shown in FIG. 3, after determining the scores at 306, 308 and 310, the engine 114 then generates a competitive set, at 330, based on a combination of the ticket size score, the proximity score, and the historic relation score for each merchant in the sample.

The competitive set may be compiled by selecting merchants having a combination of scores within a threshold range (e.g., the smallest combination of scores, highest combination of scores, all scores below a threshold value, the lowest percentage value of scores, etc.). For example, the competitive merchant set may be generated (from the sample of merchants) by selecting the (or at least the) five, eight, ten, twelve, fifteen, etc. sample merchants, whose combined ticket size score, proximity score, and historic relation score are the lowest (or highest) among the sample of merchants.

Specifically, in this exemplary embodiment, the engine 114 determines a merchant score, for each merchant in the sample, whereby the merchant score is used to generate the competitive set, at 330. For example, the engine 114 determines a merchant score for each merchant in the sample, which is based on the merchant's ticket size score, proximity score and/or historic relation score. The merchant score may be determined based on any suitable combination of the scores (e.g., by summing the scores directly, multiplying the scores, using a formula with weighted coefficients for each score, etc.), or other scores, etc. For example, a merchant score for a merchant may be determined by summing together the merchant's ticket size score, proximity score and historic relation score.

In numerous embodiments, the score for the ticket size, proximity and the historic relation (as described herein) may be further weighted, and/or generated to reflect different impact on the generated competitive set. In particular, where the ticket size is more important than proximity or the historic relation of the merchant to the target merchant 102, the ticket size score may be adjusted to reflect the importance. In one illustrative example, a ticket size score for Merchant A is 1.5, while the proximity score for Merchant A is 1.0 and the historic relation score is 1.3. And, in this example, the ticket size score for Merchant B is 1.0, while the proximity score is 1.5 and the historic relation score is 1.3. If the merchant score was the un-weighted sum of the three scores, the merchant score for Merchant A is 3.8 (i.e., 1.5+1.0+1.3), and the merchant score for Merchant B is 3.8 (i.e., 1.0+1.5+1.3). The relative merchant scores indicate Merchant A and Merchant B are equally competitive with a target merchant. But if the ticket size score was weighted to indicate emphasis, by a factor of 1.4 (where a lower score indicates a more competitive merchant), the merchant score for Merchant A is 4.4 (i.e., (1.5×1.4)+1.0+1.3), and the merchant score for Merchant B is 4.2 (i.e., (1.0×1.4)+1.5+1.3). Thus, Merchant B, who had a smaller ticket size score than Merchant A, now has a merchant score which is lower than the merchant score of Merchant A. Thus, in this example, where ticket size is emphasized over proximity and historic relation, Merchant B is more competitive to the target merchant than Merchant A.

It should be appreciated that the merchant score may be based on various different combinations of the scores, weighted or un-weighted. And, further, scores combined into the merchant score may be weighted prior to combination to the merchant score, such as in determining the ticket size score at 306, proximity score at 308, and historic relation score at 310, described above.

Although this exemplary embodiment describes first calculating a separate ticket size score, proximity score and historic relation score for each merchant in the sample and then combining them to determine a merchant score for the merchant, it is understood that in other embodiments the order of determining scores may be different. For example, a merchant score may be determined for each merchant in the sample based on ticket size data, proximity, and historic relation, without first determining separate scores for each parameter and combining them. Alternatively, the merchants in the sample at 302 may be compiled using one parameter for selection criteria (e.g., all merchants within ten miles of the target merchant 102) and the merchant score may be based on determining the remaining or all parameters (e.g., ticket size score and historic relation score). In one example, historic relation is used to compile the sample of merchants, such that all merchants within three levels of the target merchant 102 are included in the sample of merchants. Then, the merchant score is generated based on a ticket size score, a proximity score, and a historic relation score, where the historic relation score is based on the amount of overlap of the merchants appearing in the tree, and not just the presence in the tree.

Various different permutations of ticket size, proximity, and historic relation may be used, to compile a merchant sample and/or generate a competitive merchant set from merchants in the sample.

Upon generating the competitive merchant set at 330, the engine 114 stores the competitive merchant set in memory 204. Additionally, or alternatively, the engine 114 may optionally publish the competitive merchant set directly, or indirectly. For example, as shown in FIG. 3, the engine 114 optionally (as indicated by the dotted lines) determines and transmits competitor benchmark (or profile) information to a target merchant, at 332, using network interface 206. The engine 114 may determine competitor benchmark information by processing merchant information and/or transaction data stored in memory 204. The competitive benchmark information may include any information related to merchants in the generated competitive set from 330, such as, for example, an average ticket price/size of the competitive set merchants, an average ticket price per customer, spending per customer, reoccurrence of visits per customer (e.g., monthly, weekly, daily, etc.), spending by time of day, spending by day of the week, share of customer purchases for merchants in the same category, days between customer visits, number of repeat buyers over a period (e.g., 1 month, 2 or more months, etc.), percentage of new customers as a percentage of total customers, an average distance of the competitive set merchants, a volume of transactions of the competitive set merchants, etc.

The engine 114 may transmit the competitor benchmark information to a target merchant using network interface 206. In some embodiments, the names of the merchants included in the competitive set generated at 330 are not provided to the target merchant. However, anonymous average benchmark information may still benefit the target merchant by allowing the target merchant to compare its own performance with benchmarks of objectively determined competitors, for use in business planning and strategy. The competitor benchmark information may provide insights to manage and drive business strategies, including business, advertising, pricing, and/or sales decisions. For example, the target merchant may wish to compare its average ticket size to the average ticket sizes of competitors (considering consumer volume or throughput) to decide whether the target merchant should increase or decrease its prices.

In at least one embodiment, publishing the competitive merchant set, by the engine 114, may include identifying the merchants within the set to a target merchant and/or the merchants within the set, either directly, or through posting of the information to one or more locations. In other embodiments, publishing the competitive merchant set may include making the merchant set available to various entities or applications where it may be desirable to find groups of like, or similar, merchants. For example, in one application, the competitive merchant set may be used to inform a consumer that, in general, consumers who purchased products at merchant A, often also purchased products at merchants B, C, and D, one of which may be more desirable or convenient for the consumer than merchant A.

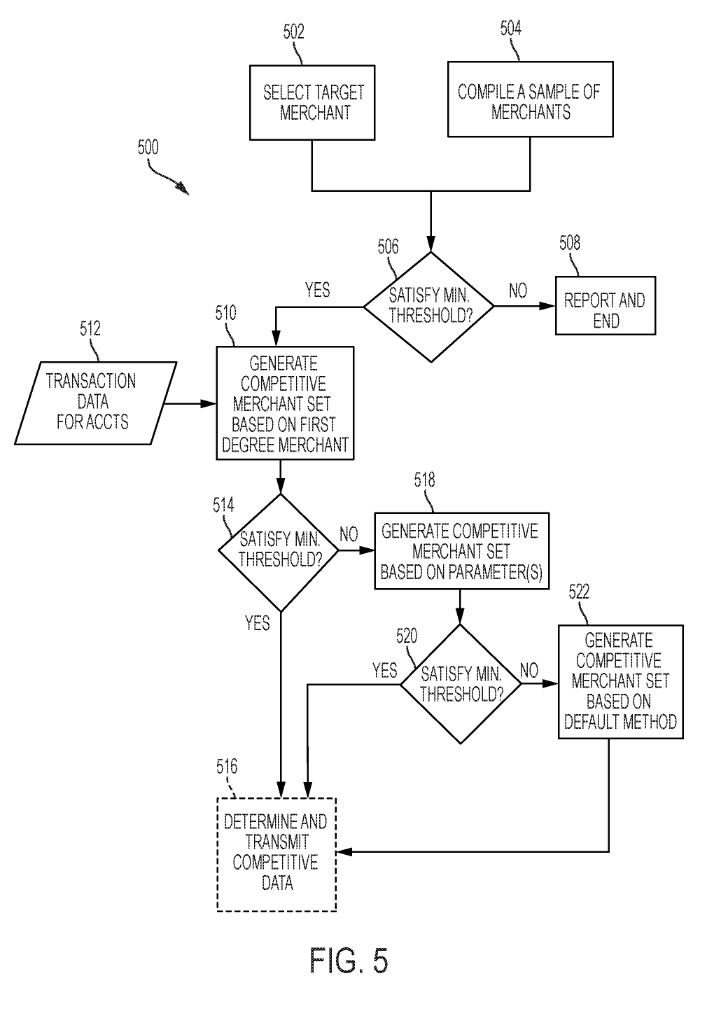

FIG. 5 illustrates another exemplary method 500 of generating a competitive merchant set for a target merchant. For purposes of illustration, the exemplary method 500 is described herein with reference to engine 114 of FIG. 1 and computing device 200 of FIG. 2. It should again be appreciated, however, that the methods described herein are not limited to the system 100 or the engine 114, or computing device 200. And, conversely, the systems and computing devices described herein are not limited to the exemplary method 500.

As part of the exemplary method 500, the engine 114 identifies a target merchant (again merchant 102 hereinafter), at 502, and compiles a sample of merchants, at 504. This may be done at about the same time, or in sequence as desired. In addition, the target merchant 102 may be selected from the sample of merchants, or conversely, the sample of merchants may be compiled based on the target merchant 102. Or, the sample of merchants may be compiled independent of the target merchant 102.

Generally, the sample of merchants is compiled based on one or more of the parameters described herein, including, for example, transaction data, merchant data, location data, or other data, etc. In this exemplary embodiment, the sample of merchants is compiled based on the location of the merchants within a region (e.g., a city, state, country, ZIP code, etc.) and an industry or category of the merchants (e.g., as indicated by MCC, etc.). It should be appreciated that one or more other parameters may be employed to compile a sample of merchants in one or more other embodiments. In at least one embodiment, compiling a sample of merchants is omitted, whereby the engine 114 relies on all merchants within a particular database, for example, as the sample of merchants in connection with further aspects of the method 500, or in connection with related aspects of other methods.

In compiling the sample of merchants, the engine 114 further accesses data from, and potentially compiles data for the sample of merchants into, a data structure, which may be used further in exemplary method 500. For example, the engine 114 may retrieve merchant information/data, such as location, etc., and transaction data for the merchant, etc., for each merchant in the sample, and add that information to the data structure (e.g., in memory 204 of the engine 114, etc.).

Next in the method 500, the engine 114 identifies a number of payment accounts associated with the target merchant 102, and determines, at 506, if the number of payment accounts satisfies a minimum number of payment accounts (or minimum threshold of payment accounts). The number of payment accounts associated with the target merchant 102 includes a number of different payment accounts involved in transactions at the target merchant 102. Then, at 506, the payment network 106 may have one or more policies, which control access, by the engine 114, to transaction data in memory 204 based on the number of payment accounts associated with the target merchant 102, to ensure, for example, that no one consumer is identifiable in any determination and/or analysis herein based on access to the transaction data. In this exemplary embodiment, the engine 114 determines, at 506, if the number of payment accounts, which have been involved in one or more transactions with the target merchant 102 (as part of the transaction data compiled), equals or exceeds a predefined number such as, for example, 5, 15, 25, 50, or 75 payment accounts. It should be appreciated that any different threshold number of payment accounts may be employed in other embodiments, based on a variety of reasons, including, for example, privacy, confidentiality, or other policies, or regulations, specific to the payment network 106, or others, etc. In some embodiments, the engine 114 performs an operation similar to 506 in compiling the sample of merchants based on similar reasons, for example, privacy, confidentiality, or other policies, or regulations, specific to the payment network 106, or others, etc.

Further, in determining the number of payment accounts associated with the target merchant 102 (or the sample of merchants), the engine 114 may limit (or filter) the payment accounts by predefined intervals (e.g., only payment accounts used at the merchant within the last month, during a particular month, within the last three months, within the last 10 months, within the last year, within a particular year or other time period, within a seasonal period (e.g., summer, sprint, fall, winter, holiday, etc.), and/or within any other interval or division of time that may be useful in determining a merchant's competitors, etc.), etc.

If the number of payment accounts associated with the target merchant 102 fails to satisfy the minimum number of payment accounts (or minimum threshold), the engine 114 ends the method 500, and reports the end condition to one or more users at 508 (who initiated the method 500, for example).

Conversely, if the minimum number of payment accounts associated with the target merchant 102 is satisfied, the engine 114 generates a set of competitive merchants, at 510. In the method 500, this competitive set of merchants represents merchants having shared consumers (or customers) with the target merchant 102, and generally includes first-degree merchants for the target merchant 102, in this example, identified from the sample of merchants compiled at 504.

In connection with generating the set of competitive merchants, at 510, the engine 114 accesses transaction data, at 512, for each payment account involved in a transaction with the target merchant (e.g., for all available transactions, or potentially for all transactions within a predefined interval, which may be the same as or different than the interval above, etc.) and identifies each additional merchant at which transactions were also made to the payment accounts. The engine 114 compares the listing of additional merchants to the sample of merchants compiled at 504, and identifies overlapping merchants. The competitive merchant set, generated at 510, in this exemplary embodiment, is limited to only the overlapping merchants that are first-degree merchants for the target merchant 102 (based on the payment accounts associated with the target merchant 102). It should be appreciated, however, that in other embodiments, a different number of degrees of other merchants, based on payment accounts associated with a target merchant (at one or multiple levels) may be employed to identify further merchants, which may be competitive with the target merchant 102, for inclusion in a competitive merchant set.

Further, the engine 114 may employ one or more filters to the competitive merchant set, defined by the first-degree merchants. For example, the engine 114 may filter out any competitive merchant who is not physically in the same market as the target merchant 102, does not have an average ticket within range of the target merchant 102, does not have a minimum number of customers in the current time period, or does not offer goods through the same channel as the target merchant 102, etc.

Once the set of merchants is compiled, at 510, the engine 114 determines if the number of merchants in the competitive merchant set satisfies a minimum threshold, at 514. In the method 500, the minimum threshold includes a minimum number of merchants in the competitive merchant set, for example, at least five, at least eight, at least another number, etc. As described above, such thresholds and/or minimums may be employed based on a variety of reasons, etc., for example, to protect identities of consumers, merchants, etc. As such, it should be appreciated that any suitable number of merchants may be set as a threshold for the merchant set in one or more other embodiments herein (depending on one or more reasons).

If the minimum threshold for the competitive merchant set is satisfied at 514, the engine 114 publishes the competitive merchant set as appropriate. In method 500, publishing the competitive data set optionally includes (as indicated by the dotted lines in FIG. 5) determining and transmitting data for the competitive merchant set, for example, in the form of a profiling/benchmarking report to the target merchant 102, etc. at 516, via network interface 206 as described above with reference to FIG. 3. Through such reporting, the target merchant 102 can compare their performance to a representative set of peer merchants, for example, in the same industry or having other common competitive features. In general, though, it should be appreciated that the target merchant 102 can use the reporting in various ways, for example, where it may be desirable to find groups of merchants that are alike, or similar, to each other, or to the target merchant 102.

Alternatively in the method 500, if the minimum threshold for the competitive merchant set is not satisfied at 514, the engine 114 generates a set of competitive merchants based on one or more various parameters, at 518 (e.g., generates an alternative competitive merchant set, etc.). This competitive set of merchants generally represents merchants having business similarities, proximity similarities, etc. with the target merchant 102 (i.e., similarities other than shared consumers (or customers)). The parameters used in generating the competitive merchant set at 518 may include, without limitation, location, sales volume, transaction volume, ticket size, combinations thereof, other parameters described herein and employed in combination therewith (excluding historic relations), etc.

In one example, the engine 114 compiles the competitive merchant set at 518 based on location of the merchants. In particular, each of the merchants within the sample of merchants, compiled at 504, includes a location expressed in latitude and longitude, which may have been part of the transaction data or may have been obtained from one or more other sources. The engine 114, in this example, then determines which of the merchants are within, for example, one degree of a location of the target merchant 102, i.e., which of the merchants are within approximately 69 miles for latitude and/or approximately 60 miles for longitude of the target merchant 102. Merchants within one degree of the target merchant 102, for both longitude and latitude, are included in the competitive merchant set at 518 (subject to one or more other parameters, for example, common industry, sales, etc.). It should be appreciated that the distance a merchant is located from the target merchant 102 may be any desired distance expressed in any desired manner in other embodiments (e.g., within a common zip code, within a common region, etc.). Further, the number of degrees for the latitude and/or longitude between a merchant and the target merchant 102 may be different than one degree in other embodiments.

In another example, the engine 114 compiles the competitive merchant set at 518 based on one or more of sales volume, volume of transactions, and average ticket sizes of the merchants (alone, or in addition to using location data for the merchants as described above). The engine 114 may include all merchants in the competitive merchant set having sales volumes within ±5%, 10%, 15%, or another percentage of the target merchant 102, which when in the same industry, for example, is indicative of close similarity of the merchants. Or, the engine 114 may include all merchants in the competitive merchant set having sales volume within a predefined monetary value of the target merchant 102 such as, for example, within $150,000, etc. In addition (or alternatively), the engine 114 may include all merchants in the completive merchant set having average ticket sizes (or other indications of ticket sizes) within a predetermined threshold of the ticket size of the target merchant 102.

Once the engine 114 has generated the competitive merchant set at 518, based on the locations of the merchants from the sample of merchants at 504, alone, or in combination with one or more other parameters, the engine 114 determines if the number of merchants in the competitive merchant set satisfies a minimum threshold, at 520 (in a similar manner to the determination at 514). If the minimum threshold is satisfied, the engine 114 may optionally (again as indicated by the dotted lines in FIG. 3) determine and transmit benchmark/profiling information/data for the competitive merchant set, for example, to the target merchant 102, etc., at 516, via network interface 206, as described above.

If the minimum threshold is not satisfied at 520, the engine 114 generates a default set of competitive merchants at 522. This default set of competitive merchants may be based, at least in part, on geography of the merchants, industry of the merchants, etc. As an example, and without limitation, the default set of competitive merchants may be generated by compiling benchmark metrics for all merchants in the same industry and market as the target merchant 102. Exclusions may then include, for example, those merchants whose metrics are ‘statistical outliers’, and whose inclusion would possibly make the benchmark inaccurate or unrepresentative of the market.

It should be appreciated that while certain thresholds (or minimums) are described with reference to method 500, that one or more similar thresholds (or minimums) may be employed in method 300 in connection with generating the competitive merchant sets and/or the reports and/or the benchmarks relating to the competitive merchant sets, and vice versa.

As can now be appreciated, exemplary systems and methods herein allow for determining a continuously representative peer set of merchants for numerous different merchant locations. Uniquely, exemplary systems and methods herein, in generating the peer sets (or competitive merchant sets), examine merchants in generally sequentially optimized flows. For example, merchants having shared consumers (or customers) with target merchants are initially identified. When insufficient merchants are found for a peer set, merchants with similar attributes and geographic proximity to the target merchants are then identified. If insufficient merchants are still found, then a default set of merchants may be used so that meaningful data can still be obtained. The systems and method therefore allow the peer sets to be developed with prior knowledge of the specific markets, based largely in part on transaction data associated with the merchants (without the need for direct input from merchants or tenuous research by the merchants, as previously required in such evaluations). The systems and methods also allow for quickly and easily updating such peer sets as new transaction data is available to the engine 114, for example.

Consistent with the description herein, competitive merchant sets include, generally, merchants, from a predetermined sample, most likely to compete with a target merchant based on one or more objective indicators. It should be appreciated that the competitive merchant sets may include any number of merchants depending on, for example, criteria (or other indicators) on which the predetermined merchant sample is compiled, and the precision and/or accuracy with which the engine 114 is generating the competitive merchant set, as described herein. In one example, a target merchant may wish to know the five most competitive merchants within 10 miles; while in another example, a target merchant may simply wish to know the 25 most competitive merchants regardless of location. The methods and systems herein may be used in a variety of different ways to provide the target merchant with an accurate indication of competition, subject to any limitations from the target merchant and based on the competitive merchant sets generated by one or more others, and relying on various parameters together or conditionally.

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) compiling, from a database of payment transactions linked by payment accounts, a sample of merchants based on at least one of: a ticket size associated with each merchant, relative to a ticket size for a target merchant, a proximity between each merchant and the target merchant, and a historic relation between each merchant and the target merchant in one or more payment accounts in the database, (b) generating a merchant score, for each merchant in the sample, based on at least the other of: the ticket size associated with each merchant, relative to the ticket size for the target merchant, the proximity between each merchant and the target merchant, and the historic relation between each merchant and the target merchant in one or more payments accounts in the database, (c) including each merchant, from the sample of merchants, in a competitive merchant set, when the merchant score for the merchant is within a threshold range; (d) compiling a sample of merchants from the database of merchants based on a geographic region and/or an industry associated with the merchants, (e) selecting one merchant from the sample of merchants as a target merchant; and (f) generating, by a computing device, a competitive merchant set for the target merchant, based on the target merchant and each merchant in the competitive merchant set overlapping within at least one payment account (i.e., first-degree merchants).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items. As used herein, the term “and/or” includes any and all combinations of one or more of the associated listed items.

In addition, although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of generating a competitive merchant set for a target merchant, from a database of merchants including transaction data relating to transactions at the merchants by multiple payments accounts, the method comprising:
compiling a sample of merchants from the database of merchants based on a geographic region and/or an industry associated with the merchants;
selecting a target merchant from the sample of merchants; and
generating from the merchants in the compiled sample of merchants, by a computing device, a competitive merchant set for the target merchant, based on the target merchant and each merchant in the competitive merchant set including at least one transaction by the same payment account.

2. The method of claim 1, further comprising determining, by the computing device, whether the competitive merchant set satisfies at least one predetermined threshold; and
determining and transmitting, by the computing device, to the target merchant, competitor benchmark data based on the generated competitive merchant set, when the competitive merchant set satisfies the predetermined threshold.

3. The method of claim 2, further comprising generating from the merchants in the compiled sample of merchants, by the computing device, an alternate competitive merchant set for the target merchant, based on a location of the merchants in the sample relative to a location of the target merchant, when the competitive merchant set fails to satisfy the predetermined threshold.

4. The method of claim 3, wherein the alternate competitive merchant set is generated based on at least one of a sales level, a merchant category code (MCC), and an average ticket size for the merchants in the alternate competitive merchant set relative to the target merchant; and
wherein the alternate competitive merchant set is generated irrespective of the target merchant and each merchant in the alternate competitive merchant set including at least one transaction to the same payment account.

5. The method of claim 3, further comprising determining, by the computing device, if the alternate competitive merchant set satisfies a predetermined threshold;
determining and transmitting, by the computing device, to the target merchant, competitor benchmark data based on the generated alternate competitive merchant set, when the alternate competitive merchant set satisfies the predetermined threshold; and
generating a default competitive merchant set for the target merchant, based on one or more industry averages for merchants in the same industry as the target merchant, when the alternate competitive merchant set fails to satisfies the predetermined threshold.

6. The method of claim 1, further comprising determining, by the computing device, if a number of payment accounts associated with the target merchant exceeds a threshold number of accounts; and
wherein generating the competitive merchant set includes generating the competitive merchant set when the number of payment accounts associated with the target merchant exceeds the threshold number of accounts.

7. The method of claim 1, wherein the competitive merchant set includes at least five merchants assigned to a same MCC as the target merchant.

8. The method of claim 1, wherein generating the competitive merchant set is based on the target merchant and each merchant in the competitive merchant set including at least one transaction to the same payment account, during a predefined interval.

9. The method of claim 1, further comprising:
for each merchant in the sample of merchants, determining, by the computing device, a merchant score based on:
a historic relation score for said merchant in the sample of merchants, based on the target merchant and said merchant in the sample of merchants including at least one transaction to the same payment account;
a proximity score for said merchant in the sample of merchants, based on a location of said merchant in the sample of merchants to a location of the target merchant; and/or
a ticket size score for said merchant in the sample of merchants, based on a ticket size for said merchant in the sample of merchants relative to a ticket size for the target merchant; and
wherein generating the competitive merchant set includes assigning each merchant in the sample of merchants, having a merchant score within a threshold range, to the competitive merchant set.

10. The method of claim 9, wherein determining the historic relation score includes:
generating, by the computing device, a relationship tree from the sample of merchants, the relationship tree including first-degree merchants to the target merchant;
wherein each first-degree merchant includes at least one transaction to the same payment account as the target merchant; and
calculating the historic relation score based on an amount of direct overlap of the merchant and the target merchant in the relationship tree.

11. A system for generating a competitive merchant set for a target merchant, the system comprising:
a computing device having a memory configured to store transaction data for multiple payment accounts involving transactions to different merchants, each payment account associated with a consumer, and a processor coupled to the memory, the processor configured to:
identify a sample of merchants from the different merchants;
generate a competitive merchant set including multiple of the merchants in the sample of merchants based on each of the multiple merchants being involved in a transaction to at least one of the multiple payment accounts, in which the target merchant is involved in a different transaction; and
publish the competitive merchant set when a number of merchant within the competitive merchant set satisfies a predefined threshold.

12. The system of claim 11, wherein the predefined threshold is a first predefined threshold; and
wherein the processor is further configured to:
generate an alternate competitive merchant set based on a location of the target merchant, when a number of merchants included within the competitive merchant set fails to satisfy a second predefined threshold; and
publish the alternate competitive merchant set when a number of merchants within the competitive merchant set satisfies the first predefined threshold.

13. The system of claim 12, wherein the alternate competitive merchant set is further based on transaction data associated with the target merchant, but not historic relation data of the target merchant and any merchant within the alternate competitive merchant set.

14. The system of claim 11, wherein the processor is configured to identify the sample of merchants based on each merchant in the sample being within a same region and a same industry.

15. The system of claim 11, wherein the predefined threshold requires at least five merchants.

16. The system of claim 11, wherein the processor is configured to:
for each merchant in the sample, determine a merchant score based on a proximity of the merchant to the target merchant, a ticket size associated with the merchant, and a historic first-degree relation between the merchant and the target merchant; and
generate the competitive merchant set based on the merchant score for each merchant.

17. A non-transitory computer readable storage media comprising executable instructions that, when executed by at least one processor, cause the at least one processor to:
identify a sample of merchants for a target merchant, based on at least a common region between the merchants in the sample of merchants and the target merchant;
generate a first competitive merchant set for the target merchant, from the sample of merchants, based on a historic relation between the target merchant and the merchants in the sample of merchants;
determine whether the first competitive merchant set includes a number of merchants that satisfies a first threshold;
publish the first competitive merchant set when the number of merchants in the first competitive merchant set satisfies the first threshold;
generate a second competitive merchant set for the target merchant based on a location associated with each merchant in the second competitive merchant set relative to a location of the target merchant, when the number of merchants in the first competitive merchant set fails to satisfy the first threshold; and
publish the second competitive merchant set when a number of merchants in the second competitive merchant set satisfies a second threshold.

18. The non-transitory computer readable storage media of claim 17, wherein the first and second competitive merchant sets include only first-degree merchants from the target merchant.

19. The non-transitory computer readable storage media of claim 17, wherein each merchant in the second competitive merchant set is included in the sample of merchants; and
wherein the instructions, when executed by the at least one processor, cause the at least one processor to identify the sample of merchants further based on an industry associated with the target merchant.

20. The non-transitory computer readable storage media of claim 17, wherein the instructions, when executed by the at least one processor, cause the at least one processor to:
generate the second competitive merchant set further based on at least one of: an average ticket size, a MCC, a sales volume, and a volume of transactions associated with the target merchant.
